(19) United States
(12) Patent Application Publication
(10) Pub. No.: US 2017/0323644 A1
(43) Pub. Date: Nov. 9, 2017

(54) SPEAKER IDENTIFICATION DEVICE AND METHOD FOR REGISTERING FEATURES OF REGISTERED SPEECH FOR IDENTIFYING SPEAKER

(71) Applicant: NEC CORPORATION, Tokyo (JP)

(72) Inventor: Masahiro KAWATO, Tokyo (JP)

(73) Assignee: NEC CORPORATION, Tokyo (JP)

(21) Appl. No.: 15/534,545

(22) PCT Filed: Dec. 7, 2015
(86) PCT No.: PCT/JP2015/006068

§ 371 Date: Jun. 9, 2017

(30) Foreign Application Priority Data
Dec. 11, 2014 (JP) 2014-250835

(51) Int. Cl. G10L 17/04; G10L 17/24; G10L 17/06

(52) U.S. Cl. CPC G10L 17/04; G10L 17/06; G10L 17/24

(57) ABSTRACT

[Problem] To suppress an erroneous identification resulting from registration speech, and identify the speaker stably and precisely.

[Solving means] The speech recognition unit 102 extracts the text data corresponding to the registration speech, as the extraction text data. The registration speech is a speech input by a registration speaker reading aloud registration target text data that is preliminarily set text data. The registration speech evaluation unit 103 calculates a score representing a similarity degree between the extracted text data and the registration target text data (registration speech score) for each registration speaker. The dictionary registration unit 104 registers the feature value of the registration speech in the speaker identification dictionary 108 for registering the feature value of the registration speech for each registration speaker, according to the evaluation result by the registration speech evaluation unit 103.

### TECHNICAL FIELD

The present invention relates to a speaker identification device and the like, for example, and a device that identifies which preliminarily registration speaker provides an input speech.

### BACKGROUND ART

A speaker identification (or a speaker recognition) is a process by a computer that recognizes (identifies or authenticates) an individual by a human voice. Specifically, in the speech identification, characteristics are extracted and modeled from a voice, and a voice of an individual is identified using modeled data.

A speaker identification service is a service that provides the speaker identification, and it is a service that identifies a speaker of input speech data.

In this speaker identification service, a commonly utilized procedure is that data such as a speech of an identification target speaker is preliminarily registered, then an identification target data is verified with the registered data. The speaker registration is called enrolling, or training.

FIG. 9A and FIG. 9B are the diagrams describing a general speaker identification service. As shown in FIG. 9A and FIG. 9B, the standard speaker identification service operates in two steps, and has two phases, i.e., a registration phase and an identification phase. FIG. 9A is an exemplary diagram of the content of the registration phase. FIG. 9B is an exemplary diagram of the content of the identification phase.

As shown in FIG. 9A, in the registration phase, at first, a user inputs registration speech (actually the name of the speaker and the registration speech) into the speaker identification service. Then, the speaker identification service extracts a feature value from the registration speech. Then, the speaker identification service stores a pair of the name of the speaker and the feature value in a speaker identification dictionary as a dictionary registration process.

As shown in FIG. 9B, in the identification phase, first, a user inputs a speech (specifically, an identification target speech) to the speaker identification service. Next, the speaker identification service extracts the feature value from the identification target speech. Then, the speaker identification service specifies the registration speech that has the same feature value as the identification target speech by comparing the extracted feature value with the feature value registered in the speaker identification dictionary. At last, the speaker identification service returns the speaker's name attached to the specified registration speech to the user as an identification result.

In the speaker identification service described in FIG. 9A and FIG. 9B, the accuracy of the speaker identification depended on the quality of the registration speech. Therefore, for example, under conditions such as when the registration speech only includes vowels, when the voice of other person than the registration target person is mixed, or when the noise level is high, the precision becomes lower than a case the speech is registered in an ideal condition. Thus, there had been a case that a practical identification precision may not be acquired depending on the content of the data stored in the identification dictionary.

MFCC (Mel-Frequency Cepstrum Coefficient) and GMM (Gaussian Mixture Model) are known as feature values shown in FIG. 9A and FIG. 9B.

In the registration phase, data stored in the identification dictionary is not always these feature values themselves. For example, a method that a classifier such as Support Vector Machine is generated utilizing a set of feature value data, and parameters of the classifier is registered to the identification dictionary (for example, Patent Literature 1), is also known.

Also, in Patent Literature 1, a similarity degree of data previously stored in a database and data that is newly registered to the database is calculated, and a registration is permitted only when the similarity degree is lower than a reference value. In an art described in Patent Literature 1, when a plurality pieces of similar data are registered, a secondary identification for calculating a similarity degree with the input speech (the identification target speech) more precisely is carried out.

However, in the art described in Patent Literature 1, in a case where data newly registered to the database does not include sufficient information, a similarity degree between a newly stored data and a registered data tends to be low. Therefore, a case existed that although data that has similar characteristics is preliminarily stored in the database, a registration of data that is going to be newly registered in the database succeeds. As a result, when a comparison is carried out, an erroneous speech identification happened.

On the other hand, Patent Literature 2 discloses an evaluation means utilizing the similarity degree with the biological information preliminarily registered to a database. In the art described in Patent Literature 2, likelihood values (similarity degree) are calculated between biological information that is going to be newly registered and each of biological information that is already registered to the database, and a registration is permitted only in a case where the likelihood value with all the registered biological information is smaller than the reference value.

With this method, for example, in a case where two speakers, i.e., a speaker A and a speaker B are registered in the database, a possibility that the speaker A is incorrectly recognized as the speaker B may be decreased, and, oppositely, a possibility that the speaker B is incorrectly recognized as the speaker A may be also decreased.

Also, for example, Patent Literatures 3 to 5 also disclose arts related to the present invention.

### CITATION LIST

### Patent Literature

[PTL 1] International Publication WO No. 2014-112375
[PTL 2] Japanese Patent No. 4588069
[PTL 3] Japanese Unexamined Patent Application Publication No. 2003-177779 (Especially Paragraphs [0009], [0010] and [0011])
[PTL 4] Japanese Unexamined Patent Application Publication No. 2003-058185
[PTL 5] Japanese Unexamined Patent Application Publication No. Hei 11-344992

### SUMMARY OF INVENTION

### Technical Problem

However, the evaluation technique described in Patent Literature 2 had a problem that, in a case where the evaluation target speech has large difference from registered biological information, but does not include sufficient information, a different person is erroneously judged as the same person, or the identical person may not identified because the judgment criteria is the similarity degree with the registered biological information.

The present invention is made considering the above-mentioned situation, and a purpose of the present invention is to provide a speaker identification device and the like that suppresses the erroneous identification resulting from the registration speech and is able to identify the speaker stably and accurately.

### Solution to Problem

The speaker identification device of the present invention includes speech recognition means that extracts, as extracted text data, text data corresponding to a registration speech that is a speech input by a registration speaker reading aloud registration target text data that is preliminarily set text data, registration speech evaluation means that calculates a score representing a similarity degree between the extracted text data and registration target text data, for each registration speaker, and dictionary registration means that registers feature value of the registration speech in a speaker identification dictionary for registering a feature value of the registration speech for each registration speaker, according to the evaluation result by the registration speech evaluation means.

The registration speech feature value registration method for speaker identification of the present invention includes extracting, as extracted text data, text data regarding to the registration speech that is input speech by a registration speaker reading aloud registration target text data that is preliminarily set text data, calculating a score representing a similarity degree between the extracted text data and the registration target text data for each registration speaker, and, according to the score calculation result, registering the feature value of the registration speech in a speaker identification dictionary for registering a feature value of the registration speech, for each registration speaker.

The storage media of the present invention stores a program that allows a computer to execute the process of: extracting, as extracted text data, text data corresponding to a registration speech that is a speech input by the registration speaker by reading aloud the registration target text data that is the preliminarily set text data; calculating, for each registration speaker, a score representing a similarity degree between the extracted text data and the registration target text data; and, according to the score calculation result, registering the feature value of the registration speech in a speaker identification dictionary for registering a feature value of the registration speech for each registration speaker.

### Advantageous Effects of Invention

With the speaker identification device and the like of the present invention, an identification error resulting from a registration speech is suppressed, and a speaker is identified stably and accurately.

### BRIEF DESCRIPTION OF DRAWINGS

FIG. 1 is a diagram showing a structure of a speaker identification system including a speaker identification server of the first exemplary embodiment of the present invention.

FIG. 2 is a diagram describing a principle of a speaker identification process of the first exemplary embodiment of the present invention.

FIG. 3 is a diagram showing an operation flow of a registration phase of a speaker identification server of the first exemplary embodiment of the present invention.

FIG. 4 is the diagram describing a score calculation process by a registration speech evaluation unit.

FIG. 5 is a diagram describing a score calculation process by the registration speech evaluation unit.

FIG. 6 is a diagram showing information stored in a temporary speech recording unit.

FIG. 7 is a diagram showing an operation flow of an identification phase of the speaker identification server of the first exemplary embodiment of the present invention.

FIG. 8 is a diagram showing a structure of the speaker identification server of the third exemplary embodiment of the present invention.

FIG. 9A is a diagram describing a general speaker identification service.

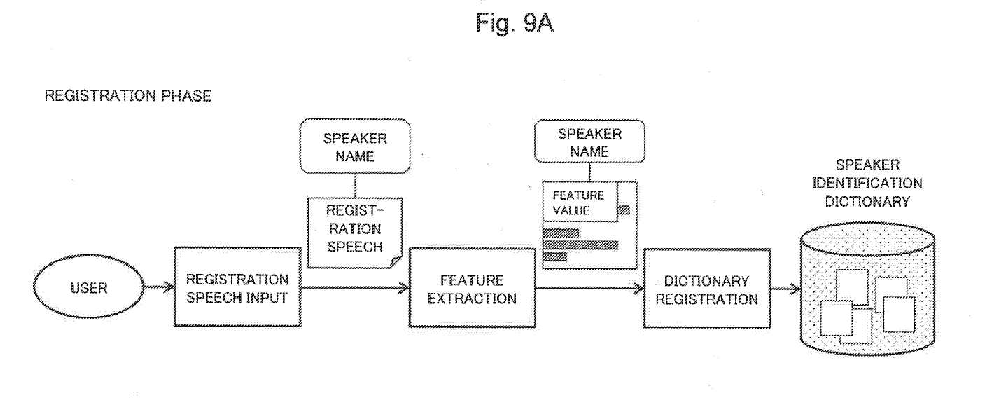

FIG. 9B is a diagram describing a general speaker identification service.

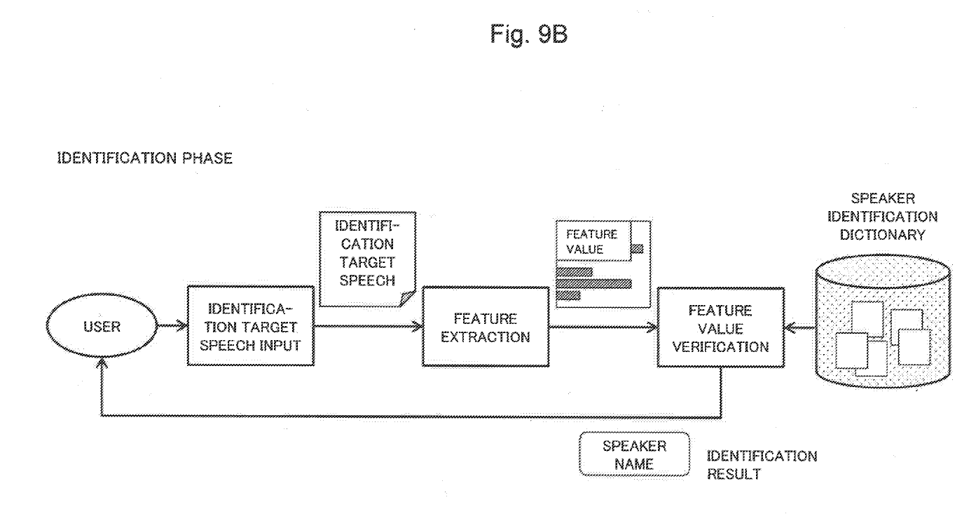

### DESCRIPTION OF EMBODIMENTS

### First Exemplary Embodiment

A structure of a speaker identification system 1000 including a speaker identification server 100 of the first exemplary embodiment of the present invention will be described.

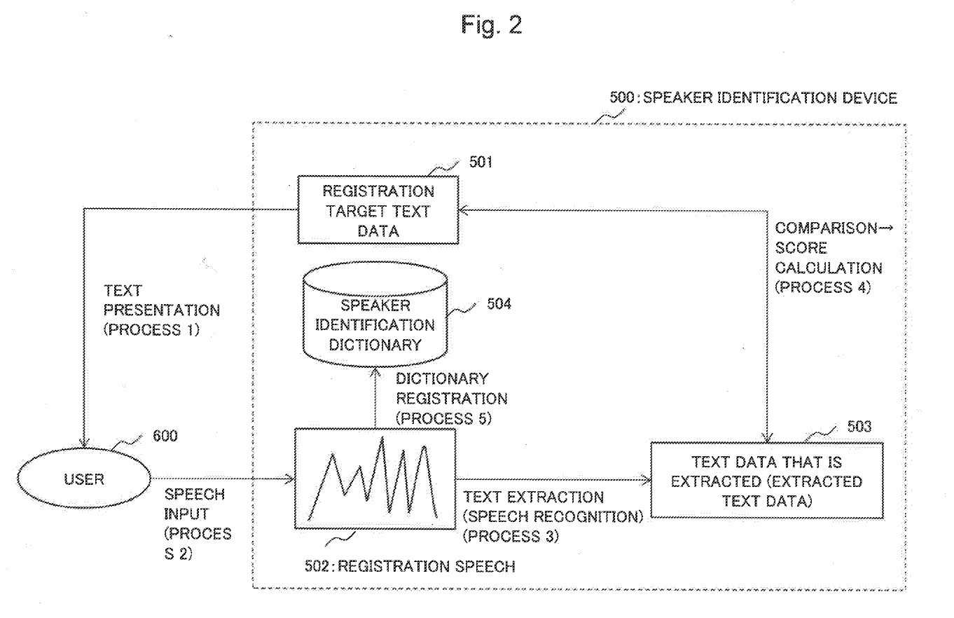

Before describing a structure of the speaker identification system 1000, a principle of a speaker identification process is described based on FIG. 2. FIG. 2 is a diagram describing the principle of the speaker identification process of the first exemplary embodiment of the present invention. A speaker identification device 500 corresponds to a speaker identification device of the present invention.

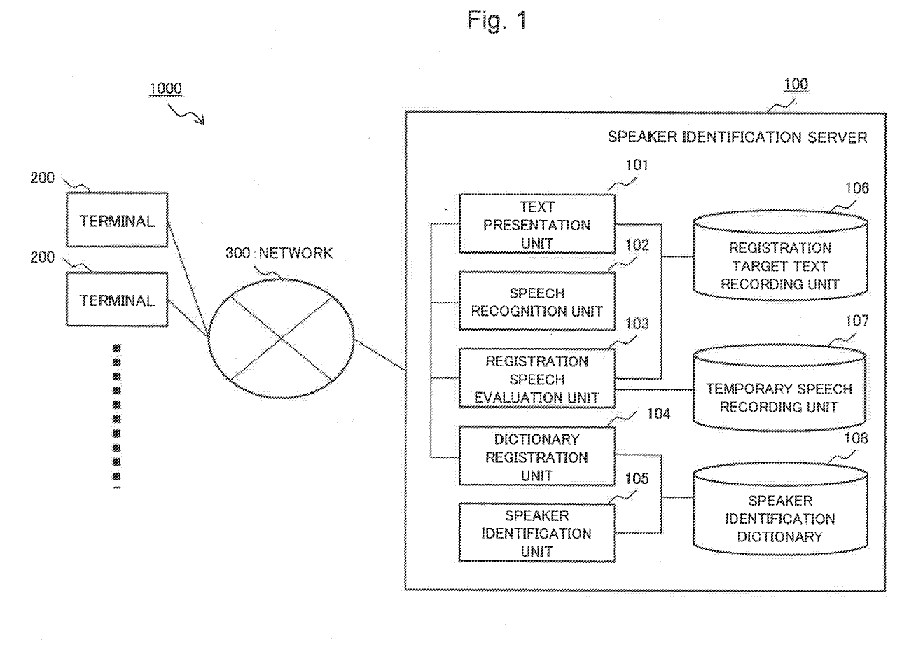

As shown in FIG. 2, the speaker identification device 500 presents a registration target text data 501 to a user 600. At this time, the speaker identification device 500 requests the user 600 to read aloud the registration target text data 501 (process 1). Here, the speaker identification device 500 corresponds to the speaker identification device of the present invention, and is equivalent to a block schematically showing a function of a speaker identification server 100 of FIG. 1.

Then, a microphone (not illustrated on FIG. 2) installed in a terminal (not illustrated in FIG. 2) collects the voice obtained by reading aloud of the user 600. Then, the voice obtained by reading aloud of the user 600 is input into the speaker identification device 500 as the registration speech 502 (process 2).

Then, the speaker identification device 500 extracts extracted text data 503 from the registration speech 502 by speech recognition (process 3).

Then, the speaker identification device 500 compares the extracted text data 503 (text extraction result) extracted in the process 3 with the registration target text data 501, and then calculates a score based on the ratio of the portion that both pieces of data match (similarity degree) (process 4).

At last, in a case where the score acquired in process 4 is equal to or larger than a reference value, the speaker identification device 500 registers a pair of the feature value extracted from the registration speech 502 and the speaker's name in a speaker identification dictionary 504 (process 5). On the other hand, in a case where the score acquired in process 4 is less than a reference value, the speaker identification device 500 retries the process 2 and processes thereafter.

It is possible to divide the whole registration target text into a plurality of partial texts (for example, a unit of sentence), repeatedly execute processes 1 to 4 for each partial text, and when the score for entire partial texts exceeds a reference value, execute the registration process of process 5 for the user.

As described above, by evaluating the quality of the registration speech using the speech recognition in the registration phase, and by registering only the feature values that have the sufficient quality, a stable identification precision is acquired.

The principle of the speaker identification process has been described above, based on FIG. 2.

Then, a structure of the speaker identification system 1000 will be described. FIG. 1 is a diagram showing a structure of the speaker identification system 1000 including the speaker identification server 100. The speaker identification server 100 corresponds to the speaker identification device of the present invention.

As shown in FIG. 1, the speaker identification system 1000 includes the speaker identification server 100 and a terminal 200. The speaker identification server 100 and the terminal 200 are connected via a network 300 such that they can be communicated with each other.

As shown in FIG. 1, the speaker identification server 100 is connected to the network 300. The speaker identification server 100 makes a communication connection to one or more terminals 200 via the network 300. More specifically, the speaker identification server 100 is the server device that executes the speaker identification against the speech data input by the terminal 200 via the network 300. Arbitrary number of, i.e., one or more terminal 200 can be connected to one speaker identification server.

As shown in FIG. 1, the speaker identification server 100 includes a text presentation unit 101, a speech recognition unit 102, a registration speech evaluation unit 103, a dictionary registration unit 104, a speaker identification unit 105, a registration target text recording unit 106, a temporary speech recording unit 107, and a speaker identification dictionary 108.

As shown in FIG. 1, the text presentation unit 101 is connected to the speech recognition unit 102, the registration speech evaluation unit 103, the dictionary registration unit 104 and the registration target text recording unit 106. The text presentation unit 101 provides a registration speaker with registration target text data that is preliminarily set text data (data including character or symbols). More specifically, the text presentation unit 101 presents the registration target text data to the registration speaker using the terminal 200 over the network 300, and promotes the registration speaker to read aloud the registration target text data. The registration speaker is the user of the terminal 200, and is the person who registers his own speech to the speaker identification server 100. The registration target text data is preliminarily set text data, and is reference text data. The registration target text data can be set arbitrarily and preliminarily.

As shown in FIG. 1, the speech recognition unit 102 is connected to the text presentation unit 101, registration speech evaluation unit 103 and the dictionary registration unit 104. The speech recognition unit 102 extracts, as extracted text data, the text data corresponding to the registration speech that is the speech input by the registration speaker reading aloud the registration target text data. In other words, when the registration speaker reads aloud the reference text data using the terminal 200, the terminal 200 sends, as the registration speech, the speech input by the registration speaker reading aloud to the speaker identification server 100 over the network 300. Then, the speech recognition unit 102 extracts, as the extracted text data, the text data from the registration speech that is the result obtained by reading aloud the registration target text data by way of speech-to-text.

As shown in FIG. 1, the registration speech evaluation unit 103 is connected to the text presentation unit 101, the speech recognition unit 102, the dictionary registration unit 104, the registration target text recording unit 106 and the temporary speech recording unit 107. The registration speech evaluation unit 103 calculates, for each registration speaker, a registration speech score that represents the similarity degree between extracted text data extracted by the speech recognition unit 102 and the registration target text data. In other words, the registration speech evaluation unit 103 calculates the registration speech score, as an index that represents quality of the registration speech, by comparing the text extraction result from the registration speech (extracted text data) with the registration target text data.

As shown in FIG. 1, the dictionary registration unit 104 is connected to the text presentation unit 101, the speech recognition unit 102, registration speech evaluation unit 103, the speaker identification unit 105 and the speaker identification dictionary 108. The dictionary registration unit 104 registers the feature value of the registration speech in the speaker identification dictionary 108 according to the evaluation result by the registration speech evaluation unit 103. More specifically, when the registration speech score calculated by the registration speech evaluation unit 103 is larger than the predetermined reference value, the dictionary registration unit 104 registers the feature value of the registration speech in the speaker identification dictionary 108. In other words, the dictionary registration unit 104 extracts the feature value from the registration speech whose registration speech score calculated by the registration speech evaluation unit 103 is larger than the reference value, and registers the extracted information in the speaker identification dictionary 108.

As shown in FIG. 1, the speaker identification unit 105 is connected to the dictionary registration unit 104 and the speaker identification dictionary 108. The speaker identification unit 105, based on the identification target speech input by the terminal 200, refers to the speaker identification dictionary 108, and identifies among the registration speakers, who owns the identification target speech.

As shown in FIG. 1, the registration target text recording unit 106 is connected to the text presentation unit 101 and the registration speech evaluation unit 103. The registration target text recording unit 106 is a storage device (or, a partial area of a storage device), and stores the registration target text data. The registration target text data is referred to by the text presentation unit 101.

As shown in FIG. 1, the temporary speech recording unit 107 is connected to the registration speech evaluation unit 103. The temporary speech recording unit 107 is a storage device (or a partial area of a storage device), and temporarily stores the registration speech input through the terminal 200.

As shown in FIG. 1, the speaker identification dictionary 108 is connected to the dictionary registration unit 104 and the speaker identification unit 105. The speaker identification dictionary 108 is a dictionary for registering the feature value of the registration speech for each registration speaker.

As shown in FIG. 1, the terminal 200 is connected to the network 300. The terminal 200 makes a communication connection to the speaker identification server 100 over the network 300. The terminal 200 includes an input device such as a microphone (not illustrated in FIG. 1) and an output device such as a liquid crystal display (not illustrated in FIG. 1). Also, the terminal 200 has a transmitting and receiving function for transmitting and receiving information with the speaker identification server 100 over the network 300. The terminal 200 is, for example, a PC (personal computer), a phone, a mobile phone, a smartphone or the like.

The structure of the speaker identification system 1000 has been described above.

Next, the operation of the speaker identification server 100 will be described. The operations of the speaker identification server 100 include two kinds of operations, i.e., operations of a registration phase and an identification phase.

Firstly, the registration phase of the behavior of the speaker identification server 100 is described. The registration phase is started when the speaker registration operation is carried out by the registration speaker to the terminal 200. In the below description, the registration target text is assumed to be composed of a plurality of texts.

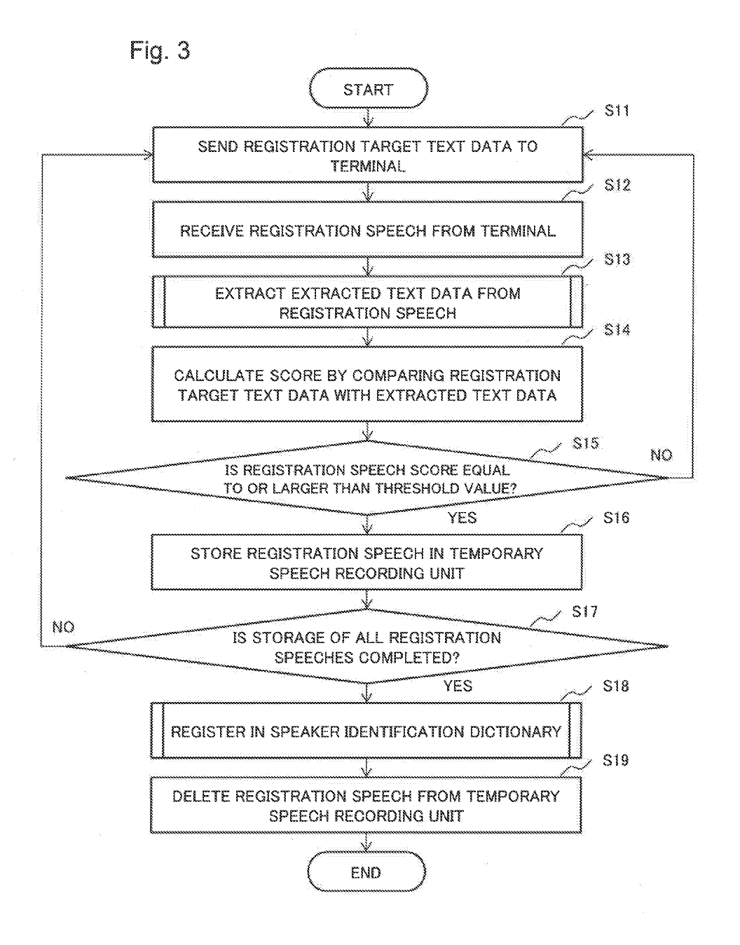

FIG. 3 is a diagram showing the operation flow of the registration phase of the speaker identification server 100.

As shown in FIG. 3, firstly, the speaker identification server 100 responds to a speaker registration request sent by the terminal 200, and sends the registration target text data to the terminal 200 (Step (hereinafter referred to as S) 11). At this time, the text presentation unit 101 acquires the registration target text data preliminarily stored in the registration target text recording unit 106, and provides this registration target text data to the registration speaker who is the user of the terminal 200. This process of S11 corresponds to the text presentation process (process 1) in FIG. 2.

Then, the terminal 200 receives the registration target text data provided by the text presentation unit 101, and requests the registration speaker who is the user of the terminal 200 to read aloud the registration target text data. After the registration speaker reads aloud the registration target text data, the terminal 200 sends the resultant data of the speech obtained by reading aloud of the registration speaker to the speaker identification server 100, as the registration speech. This process corresponds to the speech input process (process 2) of FIG. 2.

In S11, the registration target text data can be sent from the speaker identification server 100 to the terminal 200 as a telegraph, or the registration target text data can be printed on paper in advance (hereinafter referred to as registration target text paper) and then distributed to the user. In the latter case, on the registration target text paper, the registration target text added with individual number is printed out, and, in this step, the target number of the text to be read aloud is sent, to the terminal, from the speaker identification server.

Then, the speaker identification server 100 receives the registration speech sent by the terminal 200 (S12). Here, the signal of the registration speech input into the speaker identification server 100 from the terminal 200 can be either one of a digital signal expressed with encoding method such as PCM (Pulse Code Modulation) or G.729, or an analog speech signal. Also, the speech signal input here can be converted prior to the process of S13 and processes thereafter. For example, the speaker identification server 100 can receive a G.729 coded speech signal, convert the speech signal into linear PCM between S12 and S13, and configure it to be compatible with speech recognition process (S13) and dictionary registration process (S18).

The speech recognition unit 102 extracts the extracted text data from the registration speech by speech recognition (S13). In this process S13, a known speech recognition technique is utilized. In the present invention, a speech recognition art which does not require prior enrollment is used, and some of the speech recognition arts do not require prior user enrollment. This process of S13 corresponds to the text extraction process (process 3) in FIG. 2.

Then, the registration speech evaluation unit 103 compares the extracted text data extracted by the speech recognition unit 102 with the registration target text data, and calculates the registration speech score representing the similarity degree between both pieces of data for each registration speaker (S14). This process of S14 corresponds to the comparison and score calculation process (process 4).

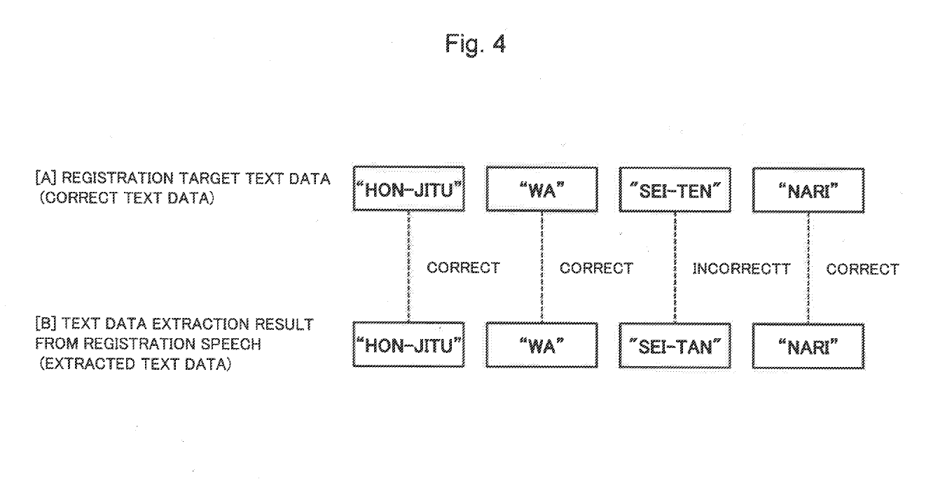

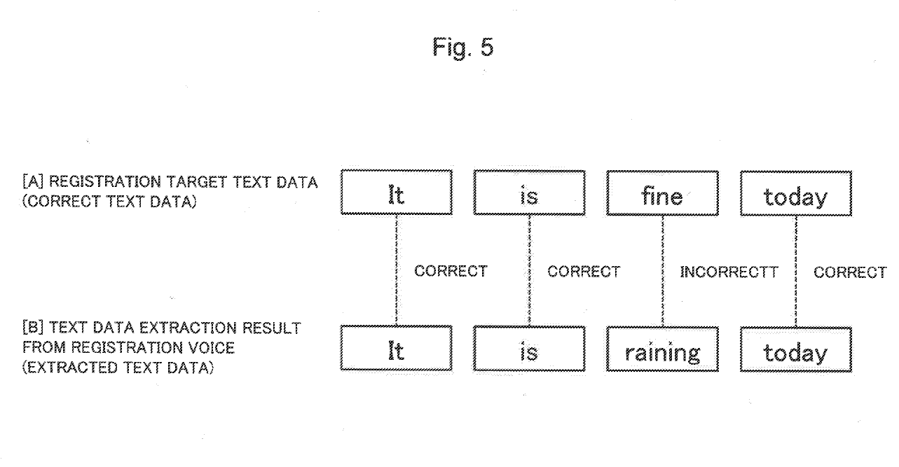

Here, the score calculation process of S14 is specifically described based on FIG. 4 and FIG. 5.

FIG. 4 and FIG. 5 are diagrams describing the score calculation process by the registration speech evaluation unit 103.

FIG. 4 shows a case that the registration target text data is in Japanese. In the top section of FIG. 4, as the correct text, [A] registration target text data is shown. In the bottom section of FIG. 4, [B] the text extraction result from the registration speech (extracted text data) is shown.

In the known speech recognition technique, the speech recognition result [B] is expressed, using a dictionary, in a unit of word, as a mix of hiragana, katakana and kanji.

The registration target text [A] used as the correct text is stored in the registration target text recording unit 106, preliminarily, in a state the text is divided in word unit. In S14, the registration speech evaluation unit 103 compares the registration target text data [A] with the extracted text data [B], word by word. Then, the registration speech evaluation unit 103 calculates, based on the comparison result of the registration target text data [A] and the extracted text data [B], the ratio of the number of words that match with the extracted text data [B] among the number of all the words in the registration target text data [A], as the registration speech score. In the example of FIG. 4, 3 of 4 words match, so the score is 3/4=0.75.

FIG. 5 shows a case that the registration target text is in English. In the top section of FIG. 5, [A] the registration target text data is shown as the correct text. In the bottom section of FIG. 5, the text extraction result from [B] the registration speech (extracted text data) is shown.

In the same manner as an example of FIG. 4, the registration speech evaluation unit 103 compares the registration target text data [A] with the extracted text data [B], word by word. Then the registration speech evaluation unit 103 calculates a ratio of the number of the words that match with the extracted text data [B] among the number of all the words in the registration target text data [A], as the registration speech score based on a result of the comparison between the registration target text data [A] and the extracted text data [B]. In the example of FIG. 5, 3 words of 4 words matches, so the score is 3/4=0.75.

Returning to FIG. 3, the dictionary registration unit 104 determines whether the registration speech score calculated by the registration speech evaluation unit 103 is larger than a predetermined threshold value (reference value) (S15).

In a case that the registration speech score calculated by the registration speech evaluation unit 103 is larger than the predetermined threshold value (reference value) (S15, YES), the dictionary registration unit 104 registers the registration speech in the speaker identification dictionary 108 and the temporary speech recording unit 107 (S16).

In a case that the registration speech score calculated by the registration speech evaluation unit 103 is equal to or less than the predetermined threshold value (reference value) (S15, NO), the speaker identification server 100 repeats the process of S11 and processes thereafter.

The speaker identification server 100 determines, for the registration target user (registration speaker), whether the registration speech corresponding to all the registration target text data is stored in the temporary speech recording unit 107 (S17).

For the registration target user (registration speaker), in a case where the registration speeches corresponding to all the registration target text data are stored in the temporary speech recording unit 107, (S17, YES), the dictionary registration unit 104 registers the registration speeches in the speaker identification dictionary 108 (S18). This S18 corresponds to the dictionary registration process in FIG. 2 (process 5).

For the registration target user (registration speaker), in a case that the registration speeches corresponding to all the registration target text data are not stored in the temporary speech recording unit 107 (S17, NO), the process of the speaker identification server 100 returns to the process of S11, and the process for other registration target text data is executed.

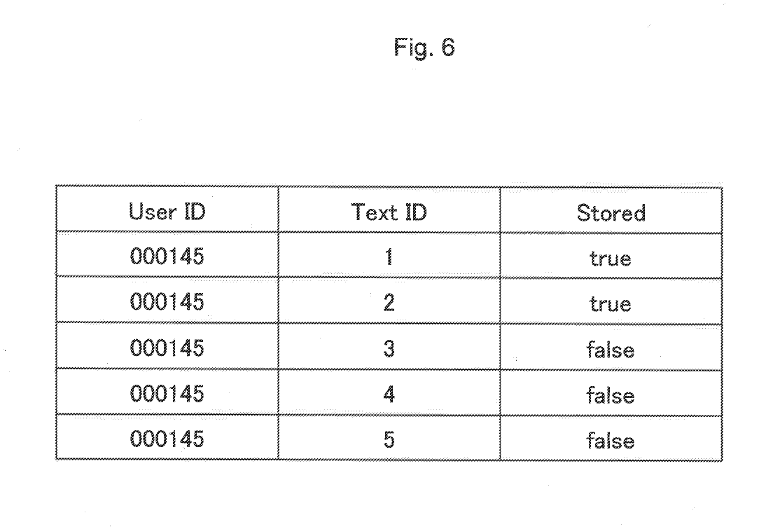

A specific example of the repetitive control in S17 is described with reference to FIG. 6. FIG. 6 is a diagram showing information stored in the temporary speech recording unit 107.

In FIG. 6, with respect to the ID “000145” of a user (registration speaker) and, each set of the registration target text data having an ID from 1 to 5, whether the corresponding registration speech is already stored in the temporary speech recording unit 107 (true/false), is shown. In this example, since pieces of the registration target text data 1 and 2 are already stored, and pieces of the registration target text data 3 to 5 are not yet stored, the speaker identification server 100 repeats the process of S11 and processes thereafter for any one of pieces of registration target text data 3 to 5.

Back in FIG. 3, at last, for the registration target user (registration speaker), all the registration speeches stored in the temporary speech recording unit 107 are deleted (S19).

The operation of the registration phase of the speaker identification server 100 has been described above.

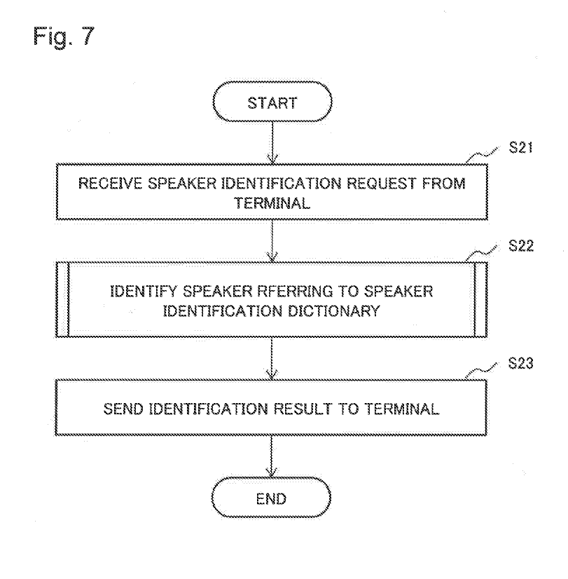

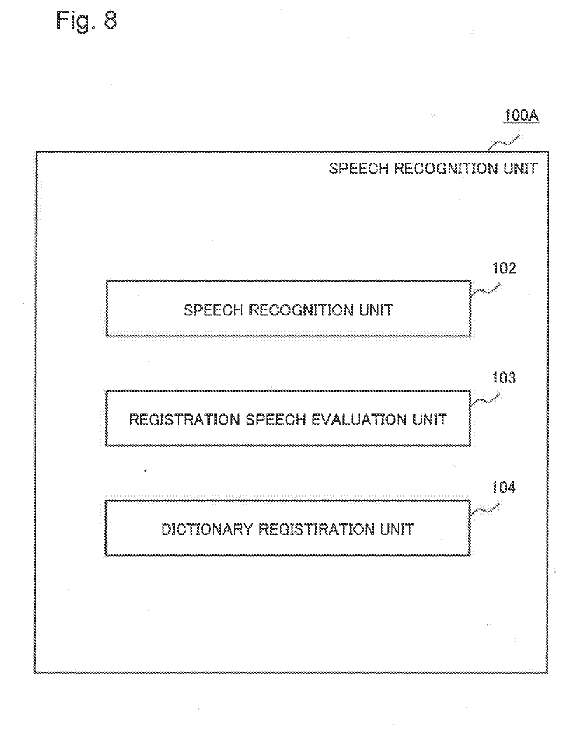

Then, the operation of the identification phase of the speaker identification server 100 will be described. FIG. 7 illustrates the operation flow of the registration phase of the speaker identification server 100. Here, the identification phase of the speaker identification server 100 is the same as the process in registration phase in FIG. 8.

As shown in FIG. 7, firstly, the speaker identification server 100 receives the speaker identification request sent from the terminal 200 (S21). In the speaker identification request, the speech data (identification target speech) recorded with terminal 200 is included as a parameter.

Then, the speaker identification unit 105 of the speaker identification server 100 identifies the registration speaker by referring to the speaker identification dictionary 108 (S22). In other words, the speaker identification unit 105 verifies the feature value of the identification target speech acquired in S21 with the feature value of the registration speech registered on the speaker identification dictionary 108. According to the above, the speaker identification unit 105 determines whether the identification target speech matches with the registration speech of any one of user IDs (Identifiers) on the speaker identification dictionary 108.

At last, the speaker identification server 100 sends the identification result by the speaker identification unit 105 to the terminal 200 (S23).

The operation of the identification phase of the speaker identification server 100 has been described above.

As described above, the speaker identification server 100 (speaker identification device) of the first exemplary embodiment of the present invention includes the speech recognition unit 102, registration speech evaluation unit 103 and the dictionary registration unit 104. The speech recognition unit 102 extracts the text data corresponding to the registration speech as the extracted text data. The registration speech is the speech input by the registration speaker reading aloud the registration target text data that is the preliminarily set text data. The registration speech evaluation unit 103 calculates a score representing the similarity degree between the extracted text data and the registration target text data (registration speech score), for each registration speaker. The dictionary registration unit 104 registers the feature value of the registration speech in the speaker identification dictionary 108 for registering the feature value of the registration speech for each registration speaker, according to the evaluation result by the registration speech evaluation unit 103.

As described above, on the speaker identification server 100 (speaker identification device), a text is extracted from the registration speech that is acquired by the registration speaker reading aloud the registration target text data. Then, based on the calculation result of the score representing a similarity degree between the extracted text data that is the text extraction result and the registration target text data, a feature value of the registration speech is registered in the speaker identification dictionary 108. In a case that the extracted text data that is the text extraction result and the registration target text data match at a high ratio, the registration speech corresponding to the extracted text data is estimated to be pronounced clearly and a noise level is sufficiently low. Also, the registration speech evaluation unit 103 calculates a score representing a similarity degree between the extracted text data and the registration target text data (registration speech score), and the dictionary registration unit 104 registers the feature value of the registration speech in the speaker identification dictionary 108, for each registration speaker, according to the evaluation result by the registration speech evaluation unit 103. Accordingly, the registration speech when the evaluation result by the registration speech evaluation unit 103 is favorable is registered in the speaker identification dictionary 108, while the registration speech in a case where the evaluation result of the registration speech evaluation unit 103 is not favorable is not registered in the speaker identification dictionary 108. Thus, only a registration speech having sufficient quality can be registered in the speaker identification dictionary 108. In this way, an identification error resulting from a registration speech with insufficient quality can be suppressed.

As described above, according to the speaker identification server 100 (speaker identification device) of the first exemplary embodiment of the present invention, an erroneous identification resulting from a registration speech with insufficient quality can be suppressed, and the speaker is identified stably and precisely. Thus, cases that a different individual is erroneously judged as the same person, or the identical person is not identified as in the evaluation art described in Patent Literature 2, are reduced.

Also, in the speaker identification server 100 (speaker identification device) of the first exemplary embodiment of the present invention, the dictionary registration unit 104 registers the feature value of the registration speech in the speaker identification dictionary 108, in a case where the score (registration speech score) is larger than a predetermined reference value.

As described above, by quantitatively judging the score (registration speech score) that is the judgment criteria of the registration of the feature value of the registration speech in the speaker identification dictionary 108, the quality of the registration speech that is registered in the speaker identification dictionary 108 can be improved in a quantitative way. Thus, the erroneous identification resulting from the registration speech with insufficient quality can be effectively suppressed, and the speaker is identified more stably and precisely.

The speaker identification server 100 (speaker identification device) of the first exemplary embodiment of the present invention includes the text presentation unit 101. The text presentation unit 101 provides the registration target text data to the registration speaker. This allows the registration target text data to be provided to the registration speaker more smoothly.

In the speaker identification server 100 (speaker identification device) of the first exemplary embodiment of the present invention, the registration speech evaluation unit 103 calculates a score representing the similarity degree between the extracted text data and the registration target text data (registration speech score), word by word, for each registration speaker. In this way, the score is calculated for each word, so the extracted text data and the registration target text data are compared with a higher degree of accuracy.

In the speaker identification server 100 (speaker identification device) of the first exemplary embodiment of the present invention, the dictionary registration unit 104 registers the feature value of the registration speech in the speaker identification dictionary 108 when all the scores for each word are larger than the predetermined reference value. Accordingly, the quality of the registration speech registered in the speaker identification dictionary 108 can be enhanced.

A feature value registration method of the registration speech for speaker identification in the first exemplary embodiment of the present invention includes: a speech recognition step; a registration speech evaluation step; and a dictionary registration step. In the speech recognition step, a text data corresponding to a registration speech is extracted as an extracted text data. The registration speech is the speech input by a registration speaker reading aloud a registration target text data that is a preliminarily set text data. In the registration speech evaluation step, a score representing a similarity degree between the extracted text data and the registration target text data (registration speech score) is calculated for each registration speaker. In the dictionary registration step, according to the evaluation result in the registration speech evaluation step, a feature value of the registration speech is registered in the speaker identification dictionary for registering the feature value of the registration speech for each registration speaker. This method also allows the same effect as the effect of the previously described speaker identification server 100 (speaker identification device) to be achieved.

A registration program of the feature value of the registration speech for speaker identification of the first exemplary embodiment of the present invention allows a computer to execute a process including the previously described speech recognition step, the previously described registration speech evaluation step, and the previously described dictionary registration step. This program also allows the same effect as the effect of the previously described speaker identification server 100 (speaker identification device) to be achieved.

A storage media of the first exemplary embodiment of the present invention stores a program that allows a computer to execute the process including the previously described speech recognition step, the previously described registration speech evaluation step, and the previously described dictionary registration step. This storage media also allow the same effect as the effect of the previously described speaker identification server 100 (speaker identification device) to be achieved.

### Second Exemplary Embodiment

Next, a structure of a speaker identification server in the second exemplary embodiment of the present invention will be described.

In the first exemplary embodiment, as an evaluation criteria of the registration speech, a comparison between a text data extracted from a registration speech with speech recognition and a registration target text data as the correct text is utilized. Here, the registration target text data as the correct text indicates the registration target text data of the S11 in FIG. 3.

In this second exemplary embodiment, as the evaluation criteria of the registration speech, kinds of phoneme included in a registration speech (example: a i, u, e, o, k, s, . . . ) are utilized. Specifically, the number of appearance of each phoneme extracted as a result of speech recognition of a registration speech is counted, and in a case the number of appearance of all kinds of phoneme reaches a reference count (example, 5 times), the registration speech is judged as including sufficient information. In a case where this condition is not satisfied, a user is requested to additionally input a registration speech, the number of phonemes included in the registration speeches until the previous time can be added, and whether the reference count (number of reference phonemes) is reached can be judged.

In a speaker identification sever (speaker identification device) of the second exemplary embodiment of the present invention, a registration speech evaluation unit compares the number of phonemes included in the extracted text data with the reference number of phonemes that is preliminarily set.

Accordingly, a correct text (in other words, registration target text) can be omitted for the calculation of the score. Thus the registration speaker can read aloud an arbitrary text when conducting a speaker registration.

### Third Exemplary Embodiment

A structure of a speaker identification server 100A of the third exemplary embodiment of the present invention is described. FIG. 8 is a diagram showing a structure of a speaker identification server 100A of the third exemplary embodiment of the present invention. Here, in FIG. 8, to the equivalent component as the respective components in FIG. 1 to FIG. 7, same symbols as those shown in FIG. 1 to FIG. 7 are allocated.

As shown in FIG. 8, the speaker identification server 100A includes a speech recognition unit 102, a registration speech evaluation unit 103, and a dictionary registration unit 104. Although not illustrated as FIG. 1, a speech recognition unit 102, a registration speech evaluation unit 103 and a dictionary registration unit 104 are connected to one another. The speech recognition unit 102, the registration speech evaluation unit 103 and the dictionary registration unit 104 are the same as the component included in the speaker identification server 100 of the first exemplary embodiment. In other words, the speaker recognition server 100A is composed of only some elements of the speaker identification server 100.

The speech recognition unit 102 extracts a text data corresponding to a registration speech as an extracted text data. The registration speech is a speech input by a registration speaker reading aloud a registration target text data that is a preliminarily set text data.

The registration speech evaluation unit 103 calculates a score representing a similarity degree between the extracted text data and the registration target text data, for each registration speaker.

The dictionary registration unit 104 registers the feature value of the registration speech, according to the evaluation result of the registration speech evaluation unit 103, in the speaker identification dictionary for registering the feature value of the registration speech for each registration speaker.

As described above, the speaker identification server 100 (speaker identification device) of the third exemplary embodiment of the present invention includes the speech recognition unit 102, the registration speech evaluation unit 103 and the dictionary registration unit 104. The speech recognition unit 102 extracts a text data corresponding to a registration speech as an extracted text data. The registration speech is the speech input by a registration speaker reading aloud a registration target text data that is a preliminarily set text data. The registration speech evaluation unit 103 calculates a score representing a similarity degree (registration speech score) between the extracted text data and the registration target text data, for each registration speaker. The dictionary registration unit 104 registers a feature value of the registration speech in the speaker identification dictionary for registering the feature value of the registration speech for each registration speaker, according to the evaluation result by the registration speech evaluation unit 103.

As described above, in the speaker identification server 100A (speaker identification device), a text is extracted from a registration speech acquired by a registration speaker reading aloud a registration target text data. Then, a feature value of the registration speech is registered in the speaker identification dictionary according to a calculation result of a score representing a similarity degree between the extracted text data that is the result of the text extraction and the registration target text data. In a case where the extracted text data that is the text extraction result matches with the registration target text data at a high rate, the registration speech corresponding to the extracted text data is estimated to be clearly pronounced, and a noise level is estimated to be sufficiently low. Also, the registration speech evaluation unit 103 calculates a score representing a similarity degree between the extracted text data and the registration target text data (registration speech score), and the dictionary registration unit 104 registers the feature value of the registration speech in the speaker identification dictionary, for each registration speaker, according to the evaluation result by the registration speech evaluation unit 103. The registration speech, in a case where the evaluation result by the registration speech evaluation unit 103 is favorable, is registered in the speaker identification dictionary, however, the registration speech in a case where the evaluation result by the registration speech evaluation unit 103 is not favorable is not registered in the speaker identification dictionary. Thus, only the registration speech with sufficient quality can be registered in the speaker identification dictionary. Erroneous identification resulting from a registration speech with insufficient quality can be thereby suppressed.

As described above, the speaker identification server 100A (speaker identification device) of the third exemplary embodiment of the present invention allows suppressing an erroneous identification resulting from a registration speech with insufficient quality, and allows a stable and precise speaker identification. Thus, as in the evaluation technique disclosed in Patent Literature 2, cases that a different individual is erroneously judged as the same person, or the identical person is not identified are reduced.

The speaker identification technique of the first to third exemplary embodiments of the present invention may be used to entire application fields of the speaker identification. Specific examples include the following. (1) A service for identifying a speech opposite party from a speech voice in a voice communication such as a telephone, (2) a device for managing entrance/exit to a building or a room, utilizing voice characteristics, and (3) a service for extracting a set of a speaker name and speech content as a text, on a telephone conference, a video conference and an image work.

The following is the comparison between Patent Literatures 3 to 5 and the present invention.

Patent Literature 3 discloses a score calculation technique based on a comparison between a speech recognition result (a text acquired as a result of speech recognition) and a correct text (reference text for comparison) and a degree of reliability of recognition (especially paragraphs [0009], [0011] and [0013]). However, the technique described in Patent Literature 3 is a general method for evaluating a result of speech recognition, and is not directly related to the present invention. Also, Patent Literature 3 discloses a process of, in a case where a score calculation result is smaller than a threshold value, applying a speaker registration learning, promoting a registration target speaker to pronounce a specific word, and updating a pronunciation dictionary using the result.

However, at least, Patent Literature 3 does not disclose a technique that the registration speech evaluation unit 103 calculates a score representing similarity degree between extracted text data and registration target text data for each word (registration speech score), for each registration speaker.

Thus, in the known speaker identification technique, for identical speaker, it is necessary to register a speech with a certain length of time (typically, around several minutes) at one time, instead of sequentially registering a short speech in a word unit to the identification dictionary.

Patent Literature 4 discloses an operation of inputting a speech pronounced by a user and a corresponding text, and storing, in a recognition dictionary, a voice feature value of the former after a speaker-specific feature is withdrawn therefrom, and a text correspondence relation of the latter (particularly in paragraph 0024). Also, a process of specifying normalization parameter to be applied, utilizing a speaker label acquired as a result of speaker recognition, for a speech recognition target speech signal, is disclosed (particularly in [0040]). However, Patent Literature 4 does not disclose a technique that at least the registration speech evaluation unit 103 calculates, for each registration speaker, a score representing a similarity degree between extracted text data and registration target text data (registration speech score) for each word.

Patent Literature 5 discloses operations of presenting random text to a newly registered user who is promoted to input speech corresponding thereto, and of creating a personal dictionary from the result (paragraph [0016]). Also, operations of calculating a verification score that is a result of verification between a speech dictionary of unspecified speakers and speech data, and registering as a part of a personal dictionary, are disclosed (particularly in paragraph [0022]).

However, Patent Literature 5 does not disclose a technique that a plurality of partial texts are presented for identical speaker.

Moreover, Patent Literature 5 discloses an operation of judging whether a person is the identical person, according to a size relation between a normalization score and a threshold value (particularly in paragraph [0024]). This is a general operation in speaker verification (equivalent to the “identification phase” of technique illustrated in FIG. 8 of the present application).

As above, the present invention has been described based on the exemplary embodiments. An exemplary embodiment is just an illustration, and various kinds of changes, addition or subtraction and combinations may be added to each of the above-mentioned exemplary embodiments unless it deviates from the main points of the present invention. It is understood by a person skilled in the art that modification made by adding such changes, addition/subtraction and combinations are also included in the scope of the present invention. The present invention has been described with reference to exemplary embodiments (and examples), but the present invention is not limited to the above described exemplary embodiments (and the examples). Various modification that could be understood by a person skilled in the art can be made to configurations and details of the present invention within a scope of the present invention.

This application claims priority based on Japanese Patent Application No. 2014-250835, filed Dec. 11, 2014, the entire disclosure of which is incorporated herein.

### REFERENCE SIGNS LIST

100, 100A Speaker Identification Server
101 Text Presentation Unit
102 Speech Recognition Unit
103 Registration Speech Evaluation Unit
104 Dictionary Registration Unit
105 Speaker Identification Unit
106 Registration Target Text Recording Unit
107 Temporary Speech Recording Unit
108 Speaker Identification Dictionary
200 Terminal
300 Network

1. A speaker identification device comprising:
a speech recognition unit means that extracts for extracting, as extracted text data, text data corresponding to a registration speech that is a speech input by a registration speaker reading aloud a registration target text data that is a preliminarily set text data;
a registration speech evaluation unit means that calculates for calculating a score representing a similarity degree between the extracted text data and the registration target text data, for each of the registration speakers; and
a dictionary registration unit means that registers for registering, according to an evaluation result by the registration speech evaluation unit means, in a speaker identification dictionary for registering a feature value of the registration speech for each of the registration speakers, the feature value of the registration speech.

2. The speaker identification device according to claim 1, wherein the dictionary registration unit means registers the feature value of the registration speech in the speaker identification dictionary in a case where the score is larger than a predetermined reference value.

3. The speaker identification device according to claim 1, comprising:
a text presenting unit means that presents for presenting the registration target text data to the registration speaker.

4. The speaker identification device according to claim 1, wherein the registration speech evaluation unit means calculates a score representing a similarity degree between the extracted text data and the registration target text data for each word, for each of the registration speaker.

5. The speaker identification device according to claim 4, wherein the dictionary registration unit registers the feature value of the registration speech in the speaker identification dictionary, when all the score for each of the words is larger than a predetermined reference value.

6. The speaker identification device according to claim 1, wherein the registration speech evaluation unit compares the number of phonemes included in the extracted text data with a preliminarily set reference number of phonemes.

7. A registration speech feature value registration method for speaker identification comprising:
extracting, as extracted text data, text data corresponding to a registration speech that is a speech input by a registration speaker reading aloud registration target text data that is preliminarily set text data;
calculating a score representing a similarity degree between the extracted text data and the registration target text data, for each of the registration speakers; and
registering, according to the score calculation result, a feature value of the registration speech in the speaker identification dictionary for registering a feature value of the registration speech for each of the registration speakers.

8. A storage media for storing a program that allows a computer to execute the process of:
extracting, as extracted text data, text data corresponding to a registration speech that is an speech input by a registration speaker reading aloud registration target text data that is preliminarily set text data;
calculating a score representing a similarity degree between the extracted text data and the registration target text data for each of the registration speakers; and
registering, according to the score calculation result, a feature value of the registration speech in a speaker identification dictionary for registering a feature value of the registration speech for each of the registration speakers.
